(19) United States
(12) Patent Application Publication
(10) Pub. No.: US 2025/0208773 A1
(43) Pub. Date: Jun. 26, 2025

(54) METHOD FOR MANAGING DISTRIBUTED DATABASE, DEVICE, AND STORAGE MEDIUM

(71) Applicant: Alipay (Hangzhou) Information Technology Co., Ltd., Hangzhou (CN)

(72) Inventor: Xiaohua YUAN, Hangzhou (CN)

(21) Appl. No.: 18/935,220

(22) Filed: Nov. 1, 2024

(30) Foreign Application Priority Data
Dec. 26, 2023 (CN) 202311814314.0

(51) Int. Cl. G06F 3/06

(52) U.S. Cl. CPC G06F 3/0631; G06F 3/0604; G06F 3/067

(57) ABSTRACT

Implementations of the present specification provide a method for managing a distributed database, a device, and a storage medium. The distributed database includes a plurality of storage nodes, the plurality of storage nodes are divided into a plurality of node groups, and each node group includes at least one storage node configured to store a data copy corresponding to the data. The method includes: receiving a data access request for the data stored in the distributed database; and determining, in response to the data access request, whether a target node group on which an online operation or maintenance task is being executed exists in the plurality of node groups; and allocating the data access request to storage nodes in node groups other than the target node group for execution in response to that the target node group exists in the plurality of node groups. Through the above manner, the distributed database can also provide an external data access service while the operation or maintenance task is executed on the distributed database.

### TECHNICAL FIELD

Implementations of the present specification relate to the field of distributed database technologies, and in particular, to a method for managing a distributed database, a device, and a storage medium.

### BACKGROUND

During running of a distributed database, some operation or maintenance tasks usually are performed on the distributed database, for example, performing capacity expansion or capacity reduction processing on storage nodes in the distributed database. In a process of executing an operation or maintenance task on the distributed database, a migration operation on a data shard stored in a storage node is often involved, for example, migrating a data shard from one storage node to another storage node. In this case, if the distributed database still provides an external data access service (for example, a data query or storage service), receives an external data access request, and accesses data stored in the storage node based on the data access request, determined storage locations of some data shards may be incorrect because the data shards are being migrated, which causes a data access failure and brings poor experience to users.

Therefore, in a related technology, when an operation or maintenance task is performed on the distributed database, the external data access service provided by the distributed database is usually suspended, and the external data access service is restarted after the operation or maintenance task is completed. Clearly, in such a manner, the distributed database cannot provide the external data access service while the operation or maintenance task is executed on the distributed database.

### SUMMARY

Implementations of the present specification provide a method for managing a distributed database, a device, and a storage medium.

According to an aspect of implementations of the present specification, a method for managing a distributed database is provided. The distributed database includes a plurality of storage nodes configured to store data, the plurality of storage nodes are divided into a plurality of node groups, and each of the plurality of node groups includes at least one storage node configured to store a data copy corresponding to the data. The method includes: receiving a data access request for the data stored in the distributed database; determining, in response to the data access request, whether a target node group on which an online operation or maintenance task is being executed exists in the plurality of node groups; and allocating the data access request to storage nodes in node groups other than the target node group for execution in response to that the target node group on which the online operation or maintenance task is being executed exists in the plurality of node groups.

According to an aspect of implementations of the present specification, a device is provided. The device includes a processor, a memory, and a computer program that is stored in the memory and can be executed by the processor, and the computer program is executed to implement the method mentioned in the first aspect.

According to an aspect of implementations of the present specification, a computer storage medium is provided. The computer storage medium stores a computer program, and the computer program is executed by a processor to implement the method mentioned in the first aspect.

The implementations of the present specification can achieve many beneficial effects. For example, in the method for managing a distributed database provided in the implementations of the present specification, a plurality of storage nodes in the distributed database can be grouped in units of data copies of data, e.g., the storage nodes in the distributed database are divided into a plurality of node groups. Each node group corresponds to one data copy of the data, and one or more storage nodes included in each node group are configured to store a complete data copy of the data. Each node group stores a complete data copy, e.g., each node group can independently provide an external service. Therefore, when an operation or maintenance task is performed on the distributed database, the operation or maintenance task can be performed in units of node groups. The operation or maintenance task is performed on only a part of the node groups at a time, and external data access services provided by the part of the node groups are suspended, but other node groups can continue to provide external data access services, so that the distributed database can also provide the external data access service while the operation or maintenance task is executed on the distributed database.

It should be understood that the above general descriptions and the following detailed descriptions are only exemplary and explanatory, and cannot limit the implementations of the present specification.

### BRIEF DESCRIPTION OF DRAWINGS

The accompanying drawings herein are incorporated into the present specification and constitute a part of the implementations of the present specification. The accompanying drawings illustrate implementations that conform to the implementations of the present specification and are used together with the present specification to explain the principle of the implementations of the present specification.

FIG. 1 is a schematic diagram illustrating migration of data stored in a distributed database between storage nodes according to an example implementation of the present specification;

FIG. 2 is a schematic diagram illustrating data storage in a distributed database in a related technology;

FIG. 3 is a schematic diagram illustrating grouping of storage nodes in a distributed database according to an example implementation of the present specification;

FIG. 4 is a flowchart illustrating a method for managing a distributed database according to an example implementation of the present specification;

FIG. 5 is a schematic diagram illustrating capacity expansion performed on a node group in a distributed database according to an example implementation of the present specification;

FIG. 6 is a schematic diagram illustrating capacity reduction performed on a node group in a distributed database according to an example implementation of the present specification;

FIG. 7 is a schematic diagram illustrating synchronization of data stored in a secondary node group in a distributed database according to an example implementation of the present specification; and

FIG. 8 is a logical block diagram illustrating a device according to an example implementation of the present specification.

### DESCRIPTION OF EMBODIMENTS

Example implementations are described in detail herein, and examples of the example implementations are presented in the accompanying drawings. When the following description relates to the accompanying drawings, unless specified otherwise, same numbers in different accompanying drawings represent same or similar elements. The implementations described in the following example implementations do not represent all implementations consistent with the implementations of the present specification. On the contrary, the implementations are merely examples of apparatuses and methods consistent with some aspects of the implementations of the present specification including those described in detail in the appended claims.

The term used in the implementations of the present specification is merely used for the purpose of describing a particular implementation and is not intended to limit the implementations of the present specification. The terms “a” and “the” of singular forms used in the implementations of the present specification and the appended claims are also intended to include plural forms, unless otherwise specified in the context clearly. It should also be understood that the term “and/or” used herein refers to and includes any or all possible combinations of one or more associated listed items.

It should be understood that although terms “first”, “second”, “third”, etc. can be used in the implementations of the present specification to describe various types of information, the information is not limited to the terms. These terms are merely used to distinguish information of a same type from each other. For example, without departing from the scope of the implementations of the present specification, first information can also be referred to as second information, and similarly, the second information can be referred to as the first information. Depending on the context, for example, the term “if” used herein can be interpreted as “in a case that . . . ”, “when . . . ”, or “in response to determining”.

A distributed database is a database system designed to process large-scale data sets. Generally, the distributed database can include a plurality of storage nodes configured to store data, and each storage node can be configured to store a part of the data. For example, one piece of data can be divided into a plurality of data shards, and the plurality of data shards can be stored in the plurality of storage nodes in a distributed manner.

During running of a distributed database, some operation or maintenance tasks usually need to be performed on the distributed database, for example, performing capacity expansion or capacity reduction processing on storage nodes in the distributed database. In a process of executing an operation or maintenance task on the distributed database, a migration operation on a data shard stored in a storage node is often involved, for example, migrating a data shard from one storage node to another storage node. In this case, if the distributed database still provides an external data access service (for example, a data query or storage service), receives an external data access request, and accesses data stored in the storage node based on the data access request, determined storage locations of some data shards may be incorrect because the data shards are being migrated, which causes a data access failure and brings poor experience to users.

For example, an operation or maintenance task is to perform capacity expansion or capacity reduction processing on the distributed database. For example, a number of storage nodes in the distributed database can be dynamically adjusted based on a current usage requirement. For example, if a number of data access requests received in the distributed database is relatively large in a current period of time, to reduce load of each storage node, capacity expansion processing can be performed on the storage nodes in the distributed database to increase the number of storage nodes in the distributed database. However, if the number of data access requests received in the distributed database is relatively small in the current period of time, to save costs, capacity reduction processing can be performed on the storage nodes in the distributed database, e.g., the number of storage nodes in the distributed database can be decreased.

In a capacity expansion or capacity reduction process, a migration operation on a data shard stored in a storage node is often involved. For example, after capacity expansion processing is performed on the storage nodes in the distributed database and a storage node is added, data shards stored in some existing storage nodes need to be migrated to the added storage node. In this case, if the distributed database still provides the eternal data access service and performs a data access operation on the storage node, the data migration operation in the capacity expansion/capacity reduction process and the data access operation possibly conflict, causing a data access failure.

For example, as shown in FIG. 1, it is assumed that the distributed database includes storage node 1, storage node 2, and storage node 3. In this case, capacity expansion processing is performed on the distributed database to add storage node 4, and a part of data shards (for example, data shard D) in the storage node 3 is to be migrated to storage node 4. If a data reading request for reading data shard D is received in a process of migrating data shard D to storage node 4, in this case, it is easy to cause a problem that a current storage location of data shard D cannot be accurately determined, resulting in a failure of a data reading operation, and consequently, a user request cannot be responded in a timely manner.

Therefore, in a related technology, when an operation or maintenance task is performed on the distributed database, the external data access service provided by the distributed database is usually suspended, and the external data access service is restarted after the operation or maintenance task is completed. Clearly, in such a manner, the distributed database cannot provide the external data access service while the operation or maintenance task is executed on the distributed database.

In some examples, the distributed database can still run stably to provide the data access service for a user after some storage nodes in the distributed database are faulty. For example, a plurality of data copies of the data are usually stored in the distributed database, and each data copy can be stored in one or more storage nodes. It is found through the applicant's analysis that, in the related technology, when the distributed database stores the data copy, distribution of data shards of the data copy in a plurality of storage nodes is usually relatively random and irregular. For example, one or more storage nodes in the distributed database that are configured to store a complete data copy often further store a data shard of another data copy. In other words, the storage nodes cannot be divided in units of data copies.

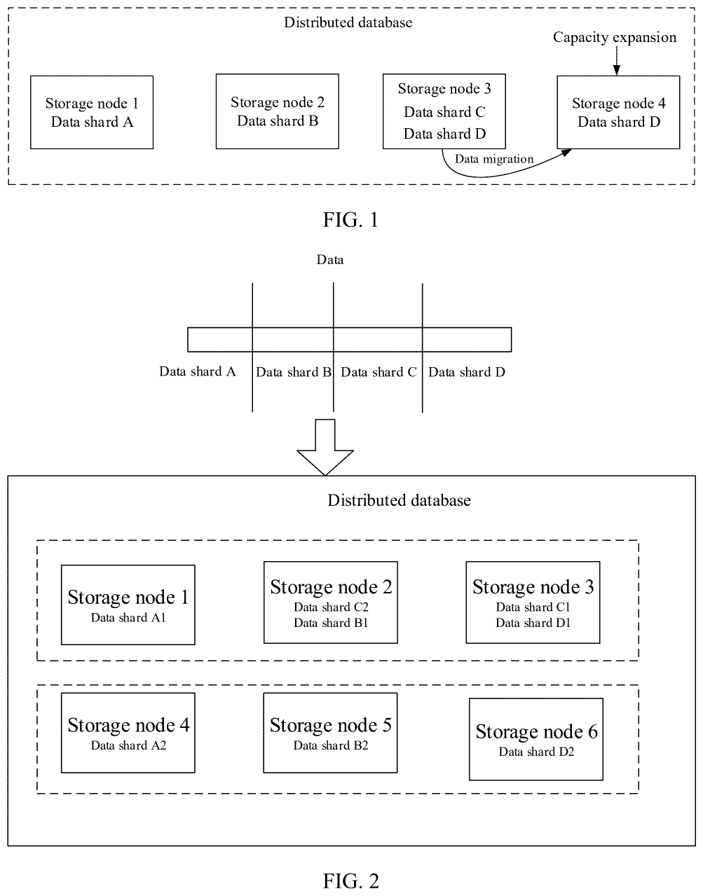

For example, as shown in FIG. 2, it is assumed that one piece of data is divided into four data shards: data shards A to D. The distributed database stores two data copies of the data: data copy 1, where data shards corresponding to the data copy are represented as data shards A1 to D1; and data copy 2, where data shards corresponding to the data copy are represented as data shards A2 to D2. Data shards corresponding to each data copy are distributed randomly in the storage nodes in the distributed database. For example, although storage nodes 1 to 3 store a complete data copy (data copy 1), storage nodes 1 to 3 also store data shard C2 in data copy 2. In other words, the storage node cannot be divided in units of data copies. When an external data access service is provided, only a node group formed by one or more storage nodes that store a complete data copy can independently provide an external service. In addition, in an operation or maintenance task process (for example, capacity expansion or capacity reduction), an operation or maintenance task is usually performed in units of node groups formed by one or more storage nodes that store a complete data copy. In the related technology, the above storage structure is used to store data, and therefore, the storage nodes cannot be divided in units of data copies. To be specific, when an operation or maintenance task is performed on a node group, a data copy stored in another node group is often incomplete, and the another node group cannot independently provide an external service. Therefore, in the operation or maintenance process, an external service of the entire distributed database is suspended.

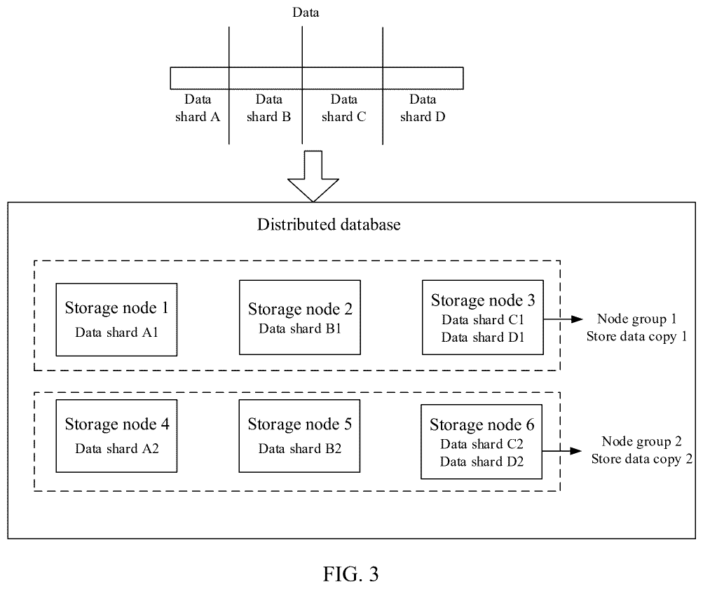

Implementations of the present specification provide a method for managing a distributed database. A plurality of storage nodes in the distributed database can be grouped in units of data copies of data, e.g., the storage nodes in the distributed database are divided into a plurality of node groups. Each node group corresponds to one data copy of the data, and one or more storage nodes included in each node group are configured to store a complete data copy of the data. For example, as shown in FIG. 3, it is assumed that data is divided into four data shards: data shards A to D. The distributed database stores two data copies of the data: data copy 1, where data shards corresponding to the data copy are represented as data shards A1 to D1; and data copy 2, where data shards corresponding to the data copy are represented as data shards A2 to D2. Storage nodes 1 to 3 in the distributed database are grouped in node group 1, and node group 1 is configured to store data copy 1. Storage nodes 4 to 6 in the distributed database are grouped in node group 2, and node group 2 is configured to store data copy 2.

The storage nodes are grouped in units of data copies, so that each node group stores a complete data copy, e.g., the node group can independently provide an external service. Therefore, when an operation or maintenance task is performed on the distributed database, the operation or maintenance task can be performed in units of node groups. The operation or maintenance task is performed on only a part of the node groups at a time, and external data access services provided by the part of the node groups are suspended, but other node groups can continue to provide external data access services, so that the distributed database can also provide the external data access service while the operation or maintenance task is executed on the distributed database.

The storage nodes in the implementations of the present specification can be various devices configured to store data, for example, a storage node can be a server.

The method for managing a distributed database provided in the implementations of the present specification can be performed by a software system (for example, can be a database engine) configured to manage and maintain the distributed database, and the software system can be deployed in one or more devices. In some scenarios, a device deployed with the software system can be a storage node. In some scenarios, a device deployed with the software system can also be a device different from these storage nodes. Ther software system may be implemented by one or more processing units. In a case that more than one processing units are involved in performing one or more operations or tasks of the software system, the more than one processors may conduct different components or portions of the one or more operations or tasks or may conduct different operations or tasks. For example, the more than one processing units may collectively conduct one or more operations or tasks. The one or more processing units may also each individually conduct one or more operations or tasks of the software system.

In some implementations, the distributed database can be a distributed graph database, and the data stored in the distributed database can be graph data.

For example, if the distributed database is the distributed graph database, the distributed graph database can be divided into a platform layer, an engine layer, and a storage layer. The three layers can be considered as a software and hardware system with a specific function. The platform layer is located at the uppermost layer and is responsible for user interface management, language query, security, cluster management, and other functions. The platform layer further provides APIs and services for connecting various client applications. The engine layer includes core functions of the graph database, such as graph traversal, query optimization, distributed computing, and data processing. The layer is responsible for converting a query of a user into an executable graph algorithm and operation, and performing computing by using a distributed computing framework. The storage layer is responsible for managing data storage and retrieval of the graph data, and responsible for storing nodes, edges, and attribute data of the graph data in a distributed environment, and providing high-performance data access and management. The storage layer is further responsible for data replication, failure transfer, and data consistency implementation. The management method can be implemented through cooperation between the above three layers.

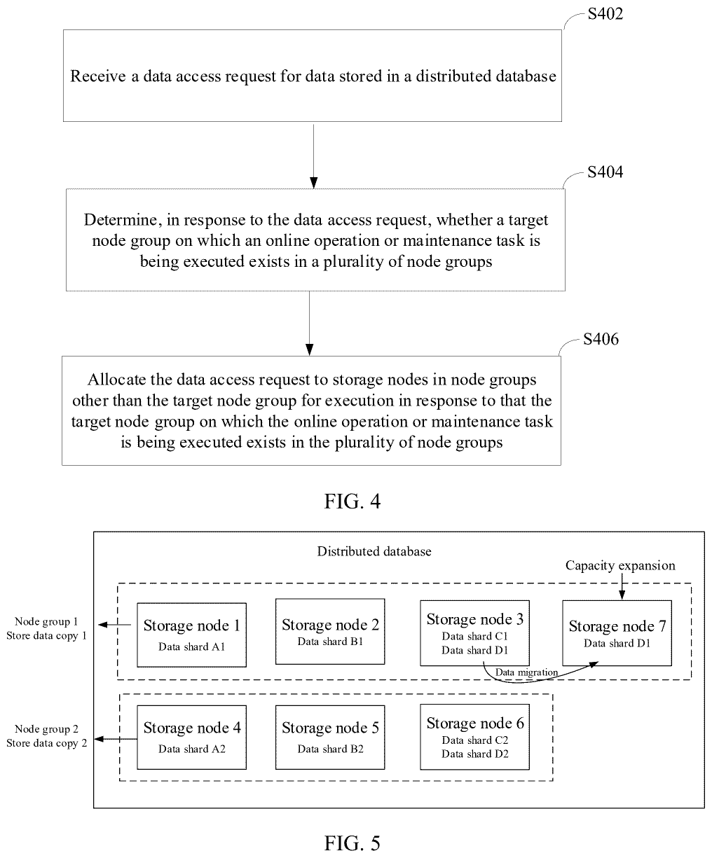

As shown in FIG. 4, the management method can include the following actions:

S402: Receive a data access request for the data stored in the distributed database.

In action S402, the data access request for the data stored in the distributed database can be received. The data access request can be an I/O request indicating that the data stored in the distributed database needs to be accessed, for example, can be a data reading request, a data writing request, or another type of request, which is not limited in the implementations of the present specification.

For example, the distributed database is a distributed graph database. When a user wants to query the graph data stored in the distributed graph database, the user can enter a query statement by using the platform layer of the distributed graph database. The platform layer can send the data access request to the engine layer based on the query statement of the user. The engine layer can determine, based on a topology structure of the distributed graph database stored at the engine layer, specific storage nodes in which to-be-accessed data is located, and then obtain related data from corresponding storage nodes at the storage layer.

S404: Determine, in response to the data access request, whether a target node group on which an online operation or maintenance task is being executed exists in the plurality of node groups.

In action S404, in response to the data access request, it can be determined whether the target node group on which the online operation or maintenance task is being executed exists in the plurality of node groups in the current distributed database. The online operation or maintenance task can be various tasks for performing operation or maintenance management on the distributed database, for example, can be a capacity expansion task or a capacity reduction task, which is not limited in the implementations of the present specification.

The online operation or maintenance task possibly involves operations such as migration of the data stored in the storage nodes, and these operations affect external services provided by the storage nodes. Therefore, to ensure that a user request can be responded to in a timely and accurate manner, the external services of these storage nodes can be suspended, e.g., the data access request is not allocated to these storage nodes.

S406: Allocate the data access request to storage nodes in node groups other than the target node group for execution in response to that the target node group on which the online operation or maintenance task is being executed exists in the plurality of node groups.

In action S406, if it is determined that the target node group on which the online operation or maintenance task is being executed exists in the current node groups, the data access request is allocated to the storage nodes in the node groups other than the target node group, so that these storage nodes process the data access request.

In some implementations, the online operation or maintenance task can be an online capacity expansion task, and the online capacity expansion task is used to add a storage node to a node group. For example, if a number of data access requests received by a node group in a current period of time is relatively large, to reduce load of the node group, capacity expansion processing can be performed on the node group to add a storage node to the node group. After the storage node is added to the node group, a part of data stored in one or more existing storage nodes can be migrated to the added storage node. For example, for data that is currently frequently accessed, a part of the data can be allocated to the added storage node. For example, as shown in FIG. 5, capacity expansion processing can be performed on node group 1 to add storage node 7, and then data shard D1 stored in the original storage node 3 is migrated to storage node 7.

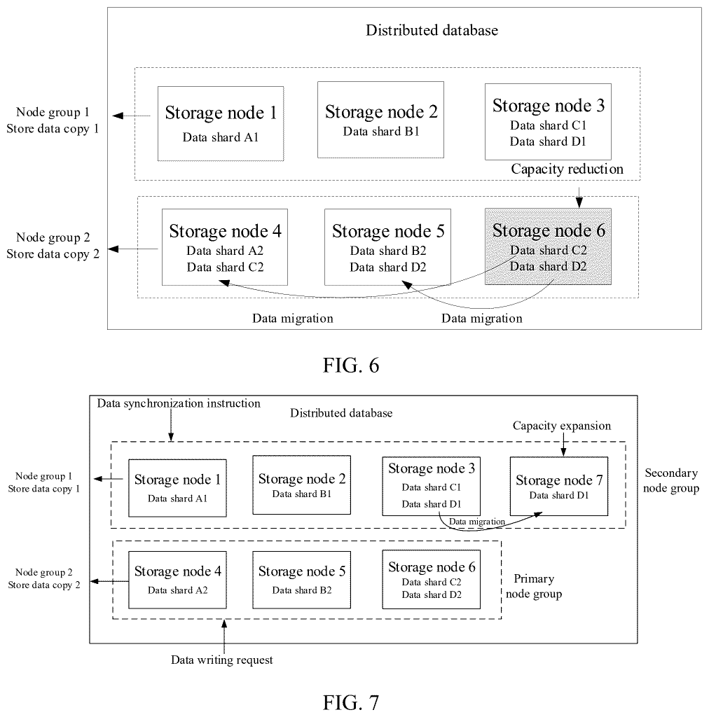

In some implementations, the online operation or maintenance task can be an online capacity reduction task, and the online capacity reduction task is used to remove a storage node from a node group. For example, if a number of data access requests received by a node group in a current period of time is relatively small, to save overheads, capacity reduction processing can be performed on the node group to remove a storage node from the node group. After the storage node is removed from the node group, data stored in the removed storage node can be migrated to another storage node. For example, as shown in FIG. 6, capacity reduction processing can be performed on node group 2 to remove the original storage node 6, and then data shard C2 stored in storage node 6 is migrated to storage node 4, and data shards D2 stored in storage node 6 is migrated to storage node 5.

In some implementations, after an instruction for performing an online operation or maintenance task on any one of the plurality of node groups is received, the online operation or maintenance task can be delivered to the node group. For example, the online operation or maintenance task is a capacity expansion task. It can be determined which storage node is added, and data shards in which storage nodes need to be migrated to the added storage node. Then, the information is delivered to a storage node in the node group, and the storage node performs the capacity expansion task based on the information.

After the instruction is received, a state of the node group can also be marked as a state of “the operation or maintenance task is being executed”, so that after the data access request is received, specific node groups to which the data access request is allocated can be determined based on the current state of the node group.

In some implementations, considering that each node group stores a complete data copy of the data, e.g., the node group can independently provide an external data access service, to balance load and increase a speed at which the distributed database responds to a user request, a traffic weight can be configured for each node group in the distributed database. A number of data access requests allocated to each node group is positively correlated with the traffic weight, e.g., a larger traffic weight corresponding to a node group indicates a larger number of data access requests allocated to the node group. The traffic weight corresponding to each node group can be determined based on a capability of processing the data access request by the node group. For example, when performance of a storage node in the node group is better, the node group can process a larger number of data access requests, and the traffic weight of the node group is larger.

The traffic weight can also be comprehensively determined with reference to other factors. For example, the traffic weight can also be determined with reference to a geographic location at which each storage node in a node group is deployed and a geographic location of a user who sends the data access request. For example, if most of users who currently send the data access request are located in city A, to increase a response speed, the data access requests can be mainly sent to node groups deployed in city A, e.g., traffic weights of the node groups deployed in city A can be set to be larger.

In some implementations, the number of data access requests allocated to each node group can be controlled by adjusting the traffic weight of the node group. For example, when an instruction for executing an online operation or maintenance task on any node group in the distributed database is received, the traffic weight of the node group can be set to 0. When the received data access request is allocated to the plurality of node groups in the distributed database, the data access request can be allocated to a node group whose traffic weight is not 0, and the data access request may not be allocated to a node group whose traffic weight is 0.

In some implementations, after the online operation or maintenance task is executed for the target node group, an external service provided by the target node group can be restarted. In this case, a performance indicator of each storage node included in the target node group can be re-determined. The performance indicator is used to indicate a capability of processing the data access request by each storage node included in the target node group. Then, a traffic weight of the target node group can be re-determined based on the performance indicator, and the traffic weight of the target node group is updated to a the traffic weight re-determined. Subsequently, the data access request can be allocated to the target node group based on the updated traffic weight.

In some implementations, considering that for a data writing request, after new data is written into a storage node in a node group, a storage node in another node group also needs to perform data synchronization, so that data copies stored in different node groups are consistent, e.g., after the data writing request is received, each node group in the distributed database needs to perform a data updating operation, the plurality of nodes can be grouped into a primary node group and a secondary node group to help determine a specific node group that is in the plurality of node groups and to which the data writing request is to allocate. The primary node group is configured to receive the data writing request and perform a data writing operation indicated by the data writing request, and the secondary node group is configured to update data stored in the secondary node group based on the latest data stored in the primary node group after the primary node group completes the data writing operation, to keep consistent with the data stored in the primary node group. The primary node group can switch between the plurality of node groups. For example, a node group whose current processing performance is best can be selected as the primary node group. Alternatively, considering that the target node group on which the online operation or maintenance task is being executed usually suspends providing of an external access service, the primary node group can also be selected from node groups other than the target node group.

After the data access request is received, it can be first determined whether the data access request is the data writing request. If yes, the data writing request is allocated to a storage node in the primary node group, for the storage node in the primary node group to perform a data writing operation corresponding to the data writing request. In addition, after performing the data writing operation, the storage node in the primary node group can send a data synchronization instruction to a storage node in the secondary node group, to trigger the storage node in the secondary node group to perform data synchronization with the storage node in the primary node group.

In some implementations, considering that a node group on which the online operation or maintenance task is being executed does not provide an external data access service, when an instruction for executing an online operation or maintenance task on any one of the plurality of node groups is received, it can be first determined whether the node group is the primary node group. If the node group is the primary node group, because the primary node group cannot process the data access request, the primary node group can be switched to the secondary node group, and a new primary node group is re-selected from original secondary node groups, so that another node group on which the online operation or maintenance task is not being executed receives the data writing request. After the primary node group is successfully switched to the secondary node group, the online operation or maintenance task can be delivered to the secondary node group switched to.

In some implementations, the data stored in the distributed database can be divided into a plurality of data shards, and each storage node included in each node group in the distributed database can be configured to store one or more data shards. Generally, for a node group on which the online operation or maintenance task is being executed, to avoid a conflict between an operation or maintenance task and a data access operation, resulting in a data access failure and affecting use experience of a user, the node group on which the online operation or maintenance task is being executed does not provide an external data access service. However, for a data synchronization task in the distributed database, the node group on which the online operation or maintenance task is being executed can still process the data synchronization task without affecting data synchronization. For example, considering that data migration does not need to be performed on all data shards in a node group in a process of executing an operation or maintenance task, data synchronization can be performed on data shards on which data migration is not performed, and for data shards on which data migration is to be performed, data synchronization processing can be performed on the data shards after data migration is performed on the data shards.

Therefore, after the storage node in the primary node group performs the data writing operation, each secondary node group can be sequentially determined as a to-be-synchronized secondary node group, and it is determined whether the to-be-synchronized secondary node group is a target secondary node group on which the online operation or maintenance task is being executed. If yes, a target data shard is determined from a data shard stored in the target secondary node group, where the target data shard is a data shard on which data migration is to be performed in the process of executing the online operation or maintenance task. Then, a first data synchronization instruction can be sent to a storage node in the target secondary node group. The first data synchronization instruction is used to instruct the storage node in the target secondary node group to perform data synchronization on a data shard other than the target data shard. In other words, when performing data synchronization, the target secondary node group on which the online operation or maintenance task is being executed performs a synchronization operation on only data shards on which data migration is not to be performed.

In some implementations, after the online operation or maintenance task is completed for the target secondary node group, a second data synchronization instruction can be sent to the storage node in the target secondary node group. The second data synchronization instruction is used to instruct the storage node in the target secondary node group to perform data synchronization on the target data shard. To ensure consistency between data stored in the node groups, for a data shard on which data migration is to be performed, data synchronization processing can be performed on the data shard after data migration is completed for the data shard.

For example, as shown in FIG. 7, it is assumed that an online capacity expansion task is being executed on node group 1. In this case, the primary node group is node group 2. After a data writing request is received, the data writing request can be delivered to a storage node in the node group 2. For example, it is assumed that the data writing request is used to indicate to write 100 pieces of data in each of data shards A2 to D2. Therefore, after receiving the data writing request, each storage node in node group 2 can perform a data writing operation to write data into the storage node. In addition, to ensure consistency between data copies stored in the node groups, after each storage node in the primary node group performs the data writing operation, a data synchronization instruction can be delivered to each storage node in the secondary node group (node group 1). To avoid a conflict with a data migration operation in the capacity expansion operation, the data synchronization instruction can instruct the storage node in the secondary node group to perform a synchronization operation on only a data shard (data shards A1 to C1) on which data migration does not need to be performed, and does not perform the synchronization operation on a data shard (data shard D1) on which data migration is to be performed. After receiving the data synchronization instruction, each storage node in the secondary node group can update, based on the latest data included in the data synchronization instruction, a data shard stored in the storage node that needs to be synchronized. After it is determined that the capacity expansion task is completed for node group 1, the data synchronization instruction can be sent to node group 1 again. The data synchronization instruction can instruct the storage node in the secondary node group to perform a synchronization operation on data shard D1.

Corresponding to the implementations of the method for managing a distributed database provided in the implementations of the present specification, the present specification further provides an apparatus for managing a distributed database. The distributed database includes a plurality of storage nodes configured to store data. The plurality of storage nodes are divided into a plurality of node groups, and each of the plurality of node groups includes at least one storage node configured to store a data copy corresponding to the data. The apparatus includes: a receiving module, configured receive a data access request for the data stored in the distributed database; a determining module, configured to determine, in response to the data access request, whether a target node group on which an online operation or maintenance task is being executed exists in the plurality of node groups; and an allocation module, configured to allocate the data access request to storage nodes in node groups other than the target node group for execution in response to that the target node group on which the online operation or maintenance task is being executed exists in the plurality of node groups.

For an implementation process of functions and roles of each unit in the apparatus, references can be made to an implementation process of corresponding actions in the above method for managing a distributed database. Details are omitted herein.

Because an apparatus implementation corresponds to a method implementation, for related parts, references can be made to related descriptions in the method implementation. The apparatus implementation described above is merely an example. The units described as separate parts may or may not be physically separate, and parts displayed as units may or may not be physical units, e.g., may be located in one place, or may be distributed on a plurality of network units. Some or all of the modules can be selected based on actual needs to achieve the objectives of the solutions in the implementations of the present specification. A person of ordinary skill in the art can understand and implement the implementations without creative efforts.

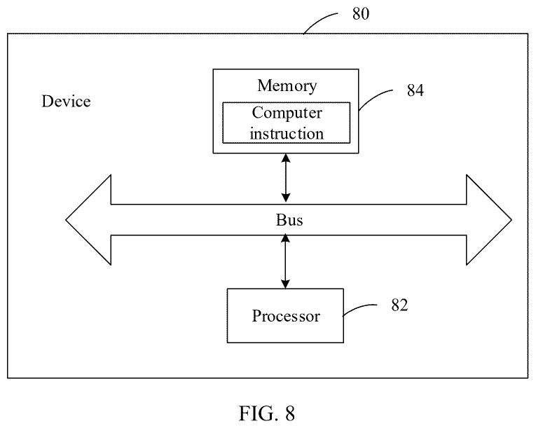

In terms of hardware level, FIG. 8 is a diagram illustrating a hardware structure of a device configured to perform the above method for managing a distributed database according to an implementation of the present specification. In addition to a processor 82 and a memory 84 shown in FIG. 8, the device can usually further include other hardware, such as a forwarding chip responsible for processing a packet. In terms of hardware structure, the device can also be a distributed device, and can include a plurality of interface cards to extend packet processing at the hardware level. The memory 84 stores computer instructions. The processor 82 executes the computer instructions to implement the method mentioned in any one of the above implementations.

User information (including but not limited to a device information of a user, personal information of a user, etc.) and data (including but not limited to data used for analysis, stored data, displayed data, etc.) used in the present application are information and data that are authorized by the user or fully authorized by each party, related data needs to be collected, used, and processed by abiding by related laws and regulations and standards of a related country and region, and a corresponding operation entry is provided, so that the user chooses to perform authorization or rejection.

The part contributing to the existing technologies in the implementations of the present specification or all or a part of the technical solutions can be implemented in a form of a software product. The computer software product is stored in a storage medium and includes several instructions for instructing a terminal device to perform all or a part of the actions of the methods in the implementations of the present specification. The above storage medium includes: any medium that can store program code, such as a USB flash drive, a removable hard disk, a read-only memory (ROM), a random access memory (RAM), a magnetic disk, or an optical disc.

The above descriptions are merely example implementations of the implementations of the present specification, but are not intended to limit the implementations of the present specification. Any modification, equivalent replacement, or improvement made without departing from the spirit and principle of the implementations of the present specification shall fall within the protection scope of the implementations of the present specification.

What is claimed is:

1. A method for managing a distributed database, the distributed database including a plurality of storage nodes configured to store data, the plurality of storage nodes being divided into a plurality of node groups, and each of the plurality of node groups including at least one storage node configured to store a data copy corresponding to the data, the method comprising:
receiving a data access request for the data stored in the distributed database;
determining, in response to the data access request, whether a target node group on which an online operation or maintenance task is being executed exists in the plurality of node groups; and
allocating the data access request to storage nodes in node groups other than the target node group for execution in response to that the target node group on which the online operation or maintenance task is being executed exists in the plurality of node groups.

2. The method according to claim 1, wherein the online operation or maintenance task includes an online capacity expansion task or an online capacity reduction task, the online capacity expansion task adds a storage node to a node group, and the online capacity reduction task removes a storage node from a node group.

3. The method according to claim 1, further comprising:
delivering the online operation or maintenance task to one of the plurality of node groups in response to a received instruction for executing an online operation or maintenance operation on the node group.

4. The method according to claim 1, wherein a traffic weight is configured for a node group of the plurality of node groups, and the traffic weight is positively correlated with a number of data access requests allocated to the node group;
the method further comprises:
setting the traffic weight of the node group of the plurality of node groups to 0 in response to a received instruction for executing an online operation or maintenance task on the node group; and
the allocating the data access request to the storage node in the node group other than the target node group includes:
allocating the data access request to a node group having a traffic weight that is not 0.

5. The method according to claim 4, further comprising:
after the online operation or maintenance task is completed for the target node group,
determining a performance indicator of a storage node included in the target node group,
and
updating the traffic weight of the target node group based on the performance indicator,
wherein the performance indicator indicates a capability of processing the data access request by the storage node.

6. The method according to claim 1, wherein the plurality of node groups include a primary node group and a secondary node group, and the data access request includes a data writing request; and
the method further comprises:
determining whether the data access request is the data writing request;
in response to that the data access request is the data writing request, allocating the data writing request to a storage node in the primary node group, for the storage node in the primary node group to perform a data writing operation corresponding to the data writing request; and
after the storage node in the primary node group performs the data writing operation, sending a data synchronization instruction to a storage node in the secondary node group, to trigger the storage node in the secondary node group to perform data synchronization with the storage node in the primary node group.

7. The method according to claim 6, wherein the data stored in the distributed database is divided into a plurality of data shards, and at least one storage node included in each of the plurality of node groups stores at least one of the plurality of data shards; and
the sending the data synchronization instruction to the storage node in the secondary node group includes:
determining a secondary node group as a to-be-synchronized secondary node group;
determining whether the to-be-synchronized secondary node group is a target secondary node group on which the online operation or maintenance task is being executed;
determining a target data shard from a data shard stored in the target secondary node group in response to that the to-be-synchronized secondary node group is the target secondary node group, wherein the target data shard is a data shard on which data migration is to be performed in a process of executing the online operation or maintenance task; and
sending a first data synchronization instruction to a storage node in the target secondary node group, wherein the first data synchronization instruction is configured to instruct the storage node in the target secondary node group to perform data synchronization on a data shard other than the target data shard.

8. The method according to claim 7, further comprising:
sending a second data synchronization instruction to the storage node in the target secondary node group after the online operation or maintenance task is completed for the target secondary node group, wherein the second data synchronization instruction is configured to instruct the storage node in the target secondary node group to perform data synchronization on the target data shard.

9. The method according to claim 6, further comprising:
determining, in response to a received instruction for executing an online operation or maintenance task on a node group of the plurality of node groups, whether the node group is the primary node group;
in response to that the node group is the primary node group, switching the primary node group to a new secondary node group and re-selecting a new primary node group from the secondary node groups except for the new secondary node group; and
after the primary node group is successfully switched to the new secondary node group, delivering the online operation or maintenance task to the new secondary node group.

10. The method according to claim 1, wherein the distributed database is a distributed graph database, and the data stored in the distributed database is graph data.

11. An electronic device, comprising one or more processors, one or more storage devices, and computer executable instructions stored in the one or more storage devices, the computer executable instructions when executed by the one or more processors, enabling the one or more processors to, individually or collectively, conduct actions including:
receiving a data access request for data stored in a distributed database, the distributed database including a plurality of storage nodes configured to store data, the plurality of storage nodes being divided into a plurality of node groups, and each of the plurality of node groups including at least one storage node configured to store a data copy corresponding to the data;
determining, in response to the data access request, whether a target node group on which an online operation or maintenance task is being executed exists in the plurality of node groups; and
allocating the data access request to storage nodes in node groups other than the target node group for execution in response to that the target node group on which the online operation or maintenance task is being executed exists in the plurality of node groups.

12. The electronic device according to claim 11, wherein the online operation or maintenance task includes an online capacity expansion task or an online capacity reduction task, the online capacity expansion task adds a storage node to a node group, and the online capacity reduction task removes a storage node from a node group.

13. The electronic device according to claim 11, wherein the actions further include:
delivering the online operation or maintenance task to one of the plurality of node groups in response to a received instruction for executing an online operation or maintenance operation on the node group.

14. The electronic device according to claim 11, wherein a traffic weight is configured for a node group of the plurality of node groups, and the traffic weight is positively correlated with a number of data access requests allocated to the node group;
the actions further include:
setting the traffic weight of the node group of the plurality of node groups to 0 in response to a received instruction for executing an online operation or maintenance task on the node group; and
the allocating the data access request to the storage node in the node group other than the target node group includes:
allocating the data access request to a node group having a traffic weight that is not 0.

15. The electronic device according to claim 14, wherein the actions further include:
after the online operation or maintenance task is completed for the target node group,
determining a performance indicator of a storage node included in the target node group,
and
updating the traffic weight of the target node group based on the performance indicator,
wherein the performance indicator indicates a capability of processing the data access request by the storage node.

16. The electronic device according to claim 11, wherein the plurality of node groups include a primary node group and a secondary node group, and the data access request includes a data writing request; and
the actions further include:
determining whether the data access request is the data writing request;
in response to that the data access request is the data writing request, allocating the data writing request to a storage node in the primary node group, for the storage node in the primary node group to perform a data writing operation corresponding to the data writing request; and
after the storage node in the primary node group performs the data writing operation, sending a data synchronization instruction to a storage node in the secondary node group, to trigger the storage node in the secondary node group to perform data synchronization with the storage node in the primary node group.

17. The electronic device according to claim 16, wherein the data stored in the distributed database is divided into a plurality of data shards, and at least one storage node included in each of the plurality of node groups stores at least one of the plurality of data shards; and
the sending the data synchronization instruction to the storage node in the secondary node group includes:
determining a secondary node group as a to-be-synchronized secondary node group;
determining whether the to-be-synchronized secondary node group is a target secondary node group on which the online operation or maintenance task is being executed;
determining a target data shard from a data shard stored in the target secondary node group in response to that the to-be-synchronized secondary node group is the target secondary node group, wherein the target data shard is a data shard on which data migration is to be performed in a process of executing the online operation or maintenance task; and
sending a first data synchronization instruction to a storage node in the target secondary node group, wherein the first data synchronization instruction is configured to instruct the storage node in the target secondary node group to perform data synchronization on a data shard other than the target data shard.

18. The electronic device according to claim 17, wherein the actions further include:
sending a second data synchronization instruction to the storage node in the target secondary node group after the online operation or maintenance task is completed for the target secondary node group, wherein the second data synchronization instruction is configured to instruct the storage node in the target secondary node group to perform data synchronization on the target data shard.

19. The electronic device according to claim 6, wherein the actions further include:
determining, in response to a received instruction for executing an online operation or maintenance task on a node group of the plurality of node groups, whether the node group is the primary node group;
in response to that the node group is the primary node group, switching the primary node group to a new secondary node group and re-selecting a new primary node group from the secondary node groups except for the new secondary node group; and
after the primary node group is successfully switched to the new secondary node group, delivering the online operation or maintenance task to the new secondary node group.

20. A computer storage medium, wherein the computer storage medium stores a computer program, the computer program, when executed by one or more processors, enabling the one or more processors to, individually or collectively, to implement actions including:
receiving a data access request for data stored in a distributed database, the distributed database including a plurality of storage nodes configured to store data, the plurality of storage nodes being divided into a plurality of node groups, and each of the plurality of node groups including at least one storage node configured to store a data copy corresponding to the data;
determining, in response to the data access request, whether a target node group on which an online operation or maintenance task is being executed exists in the plurality of node groups; and
allocating the data access request to storage nodes in node groups other than the target node group for execution in response to that the target node group on which the online operation or maintenance task is being executed exists in the plurality of node groups.
